(19) United States
(12) Patent Application Publication
(10) Pub. No.: US 2025/0111659 A1
(43) Pub. Date: Apr. 3, 2025

(54) TRANSFER LEARNING

(71) Applicant: AUTOBRAINS TECHNOLOGIES LTD, Tel Aviv-Yafo (IL)

(72) Inventor: Shay Leizerovitch, Mikhmoret (IL)

(73) Assignee: AUTOBRAINS TECHNOLOGIES LTD, Tel Aviv-Yafo (IL)

(21) Appl. No.: 18/479,806

(22) Filed: Oct. 2, 2023

(51) Int. Cl. G06V 10/82; G06V 10/77

(52) U.S. Cl. CPC G06V 10/82; G06V 10/7715

(57) ABSTRACT

A method for transfer learning, including (a) obtaining new object images and new object bounding shape information indicative of new object bounding shapes; (b) feeding the new object images to a NN that is trained to detect the certain objects, (c) providing, per each layer out of a group of candidate layers and for each new object image of the new object images, (i) a features map regarding a new object bounding shape, and (ii) a features map regarding an external region; (d) building, per each layer out of a group of candidate layers of the NN, an object classifier configured to distinguish between a bounding shape region and an external region; (e) selecting, out of the group of candidates layers, a selected layer; and (f) associating the selected layer with a detection of the new object.

### BACKGROUND

A neural network may include an input layer, multiple hidden layers and an output layer.

The neural network may be trained to detect certain objects. The training process involves feeding to the neural network images that capture the certain objects, applying a loss function on the features of the output layer, and amending (when necessary) the neural network based on the outcome of the output layer. The training process may be time and resource consuming.

Such a neural network may be sub-optimal for detecting other objects.

There is a growing need to convert a neural network trained to detect certain objects to a neural network that may also detect other objects.

### BRIEF DESCRIPTION OF THE DRAWINGS

The embodiments of the disclosure will be understood and appreciated more fully from the following detailed description, taken in conjunction with the drawings in which:

FIG. 1 is an example of a method;

FIG. 2 is an example of a method;

FIG. 3 is an example of an image of a vehicle;

FIG. 4 illustrates an example of a neural network, feature maps and features;

FIG. 5 illustrates an example of features and classifiers.

### DESCRIPTION OF EXAMPLE EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a device or computerized system capable of executing the method and/or to a non-transitory computer readable medium that stores instructions for executing the method.

Any reference in the specification to a computerized system or device should be applied mutatis mutandis to a method that may be executed by the computerized system, and/or may be applied mutatis mutandis to non-transitory computer readable medium that stores instructions executable by the computerized system.

Any reference in the specification to a non-transitory computer readable medium should be applied mutatis mutandis to a device or computerized system capable of executing instructions stored in the non-transitory computer readable medium and/or may be applied mutatis mutandis to a method for executing the instructions.

Any combination of any module or unit listed in any of the figures, any part of the specification and/or any claims may be provided.

The specification and/or drawings may refer to an image. An image is an example of a media unit. Any reference to an image may be applied mutatis mutandis to a media unit. A media unit may be an example of sensed information unit. Any reference to a media unit may be applied mutatis mutandis to sensed information. The sensed information may be sensed by any type of sensors-such as a visual light camera, or a sensor that may sense infrared, radar imagery, ultrasound, electro-optics, radiography, LIDAR (light detection and ranging), etc.

The specification and/or drawings may refer to a processor. The processor may be a processing circuitry. The processing circuitry may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

Any combination of any steps of any method illustrated in the specification and/or drawings may be provided.

Any combination of any subject matter of any of claims may be provided.

Any combinations of computerized systems, units, components, processors, sensors, illustrated in the specification and/or drawings may be provided.

Any reference to any of the term “comprising” may be applied mutatis mutandis to the terms “consisting” and “consisting essentially of”.

Any reference to any of the term “consisting” may be applied mutatis mutandis to the terms “comprising” and “consisting essentially of”.

Any reference to any of the term “consisting essentially of” may be applied mutatis mutandis to the terms “comprising” and “comprising”.

Reference to “may be A”, indicates that according to an embodiment A is applied and/or A exists and/or A is a part of a solution.

There is provided a method, system and non-transitory computer readable medium (hereinafter solution) for transfer learning- and especially for converting a neural network trained to detect certain objects to a neural network (NN) that may also detect other objects.

The solution includes receiving information regarding a new object (a new object is an object for which the neural network was not trained to detect) and finding a selected layer of the NN that outputs features that enable to detect the new object. The selected layer may be the best fit layer to the task or may at least provide a satisfactory chance to detect the new object.

The selected layer may form the start of a NN head that should be trained to detect the new object, based on the features outputted from the selected layer.

Using the selected layer to detect the new object improves the accuracy of the neural network and saves resources by not needing to use a more resource consuming neural network to detect the new object. Using a NN head to detect a new object is more cost effective than replacing the NN by an completely new NN and training the new NN to detect the new object.

The suggested solution does not require prior knowledge or analysis of the different layers of the NN and/or the features outputted by the NN and/or the expected response of the NN to the new object.

The suggested solution does provide an optimal result—of high object detection accuracy—by basing the selection of a layer based on classifies that are fed from candidate layers of the NN.

During a training of the NN head, the weights of the NN head may be adjusted—while other layers of the NN may not be adjusted—which also greatly reduces (by a factor that ranges between 1.1 and 1000) of at least the computational resources required for training.

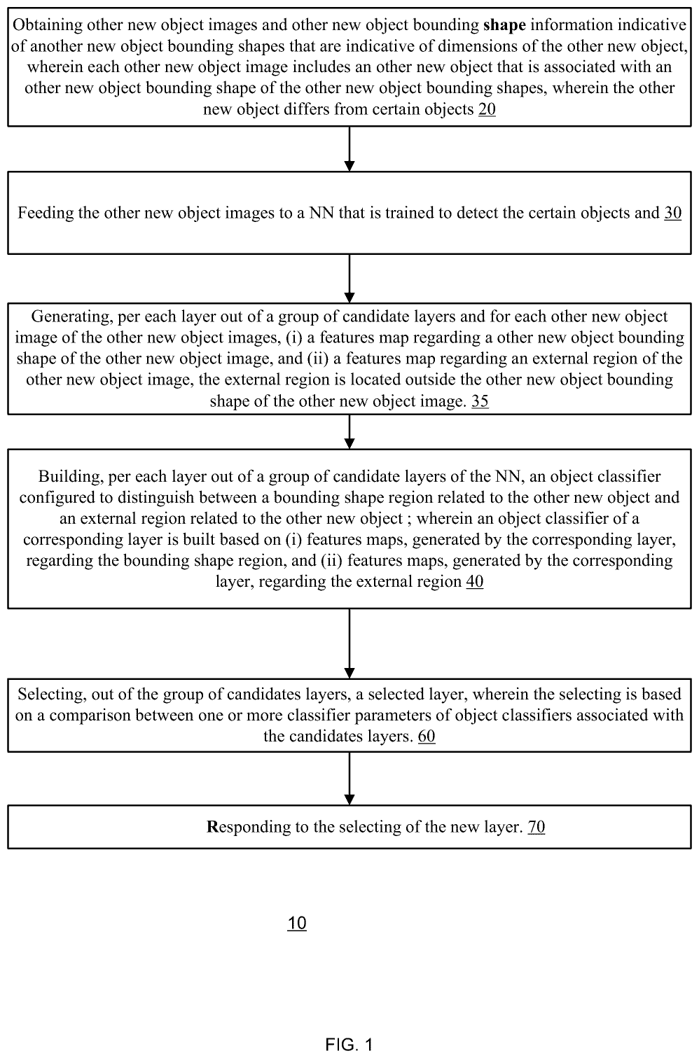

FIG. 1 illustrates method 10 for transfer learning.

According to an embodiment, method 10 starts by step 20 of obtaining new object images and new object bounding shape information indicative of new object bounding shapes that are indicative of dimensions of a new object, wherein each new object image includes a new object that is associated with a new object bounding shape of the new object bounding shapes, wherein the new object differs from certain objects.

Bounding shape information describes one or more bounding shapes. A bounding shape is associated with an object and is indicative of the dimensions (for example height and/or width and/or length) of the object. A bounding shape may or may not surround the object. Even when not surrounding the object—the borders of bounding shape are usually located in proximity to edges of the object. Usually the bounding shape surrounds a majority (for example—more than 60%, 70%, 80% or 90%) of the area of the object. A bounding shape may be a bounding box or a bounding polygon that is not a box or have any shape other than a box—including a curved shapes, a partially curves shape, and the like.

According to an embodiment, step 20 is followed by step 30 of feeding the new object images to a neural network (NN) that is trained to detect the certain objects.

According to an embodiment, the method includes training the NN or receiving the NN already trained.

According to an embodiment, the new object is located within the bounding shape region while other content (for example background content or other content that differs from the new object) is located within the external region.

According to an embodiment, the new object is located at the center of the BR. Features of the center of the BR should be distinguished from features outside the center of the BR.

According to an embodiment, step 30 is followed by step 35 of providing, per each layer out of a group of candidate layers and for each new object image of the new object images, (i) a features map regarding a new object bounding shape of the new object image, and (ii) a features map regarding an external region of the new object image, the external region is located outside the new object bounding shape of the new object image.

For example, assuming that the group of candidate layers are the group-new layer till the group-last layers of the NN-denoted Gf′th layer till the Gl′th layer.

Each layer of the Gf′th till the Gl′th layer generates a BR features map and the ER feature map.

For simplicity of explanation it is assumed that the NN includes (M+1) layers and that the Gf′th layer is the 2^{nd} layer and that the Gl′th layer is the M′th layer. Other layers may be the Gf′th layer (first or more than second) and the Gl′th layer (before the M′th layer).

According to an embodiment, step 35 is followed by step 40 of building, per each layer out of a group of candidate layers of the NN, an object classifier configured to distinguish between a bounding shape region related (BR) to the new object and an external region (ER) related to the new object. An object classifier of a corresponding layer is built based on (i) features maps, generated by the corresponding layer, regarding the bounding shape region, and (ii) features maps, generated by the corresponding layer, regarding the external region. According to an embodiment, the features maps are built in relation to the new object images and the features maps are related to the bounding shape regions and the external regions of the new object images. The object classifier should distinguish between bounding shape regions and external regions in future images that capture the new object. The future images may be capture during inference and/or testing.

Thus—for the 2^{nd} till (M) layers there are (M−2) classifiers.

It should be noted that the classifier may be required to distinguish between features associated with the center of the BR—and other features. This may occur, for example, when trying to distinguish between a specific object and the background.

The object classifier may be of any type—for example may be calculated using a regression model (for example linear regression model), using support vector machines (SVMs) that are a set of supervised learning methods used for classification, regression and outliers detection, and the like.

A layer may be regarded as a relevant candidate if the classifier associated with the layer exhibits at least a predefined separability between the new object and other objects—for example may provide at least a predefined separability between BBB features and ER features. The separability may be measured using a sensitivity index.

If there is no classifier (of the M−2 classifiers) that exhibits at least the predefined separability—the method may determine that the new object may not be properly detected by the NN.

The NN may be a convolutional NN.

Thus—for index m that ranges between 2 and M−2 the m′th classifier is built based on the m′th BR feature map and the m′th ER feature map.

According to an embodiment, step 40 is followed by step 50 of selecting, out of the group of candidates layers, a selected layer, wherein the selecting is based on a comparison between one or more classifier parameters of object classifiers associated with the candidates layers.

An example of a classifier parameter is a sensitivity index.

According to an embodiment, the best candidate (for example—the laser associated with the classifier having the highest sensitivity index) is selected.

According to an embodiment, step 50 is followed by step 60 of responding to the selecting of the new layer.

According to an embodiment, step 60 includes at least one out of:
Associating the first selected layer with a detection of the new object.
Adding a new branch to the NN, wherein the branch starts from the first selected Layer.
Training the new branch to detect the current object and generate a bounding shape around the current object.

According to an embodiment, method 10 is executed multiple times—for multiple new candidates.

For example—let's assume that a first iteration of method 10 is dedicated to a new object that is referred to as a first object. Another iteration of method 10 may be dedicated to another new object that is referred to as a second object. In this case—the other iteration of method 10 includes:
obtaining other new object images and other new object bounding shape information indicative of another new object bounding shapes that are indicative of dimensions of the other new object, wherein each other new object image includes an other new object that is associated with an other new object bounding shape of the other new object bounding shapes, wherein the other new object differs from certain objects;
feeding the other new object images to a NN that is trained to detect the certain objects.
Generating, per each layer out of a group of candidate layers and for each other new object image of the other new object images, (i) a features map regarding a other new object bounding shape of the other new object image, and (ii) a features map regarding an external region of the other new object image, the external region is located outside the other new object bounding shape of the other new object image;
building, per each layer out of a group of candidate layers of the NN, an object classifier configured to distinguish between a bounding shape region related to the other new object and an external region related to the other new object; wherein an object classifier of a corresponding layer is built based on (i) features maps, generated by the corresponding layer, regarding the bounding shape region, and (ii) features maps, generated by the corresponding layer, regarding the external region;
selecting, out of the group of candidates layers, a selected layer, wherein the selecting is based on a comparison between one or more classifier parameters of object classifiers associated with the candidates layers; and
associating the selected layer with a detection of the other new object.

Each iteration may select a selected layer.

The selection can be made regardless of the selection made in another iteration.

Yet for another example—the selection of one iteration may impact the selection of another iteration—or the response to the selection of another iteration. For example—if different iterations elect the same layer—then the responding to the selection may include having separate heads that branch from the seme selected layer. Alternatively—at least one head from the same selected layer should be trained to detect different objects—and distinguish between the different objects.

According to an embodiment, the classifier applies a TF/IDF classification. The TF/IDF classification (term frequency-inverse document frequency) is a numerical statistic that is intended to reflect how important a word is to a document in a collection or corpus. It is often used as a weighting factor in searches of information retrieval, text mining, and user modeling. The tf-idf value increases proportionally to the number of times a word appears in the document and is offset by the number of documents in the corpus that contain the word, which helps to adjust for the fact that some words appear more frequently in general. tf-idf is one of the most popular term-weighting schemes today. (WIKIPEDIA™). Variations of the tf-idf weighting scheme are often used by search engines as a central tool in scoring and ranking a document's relevance given a user query. tf-idf can be successfully used for stop-words filtering in various subject fields, including text summarization and classification.

The DF may be one or more features related to the center of the BBR that bounds the new object—while the IDF may include one or more feature related to other locations.

It should be noted that other classification schemes may be applied and that the tf-idf is just an example of a classification scheme.

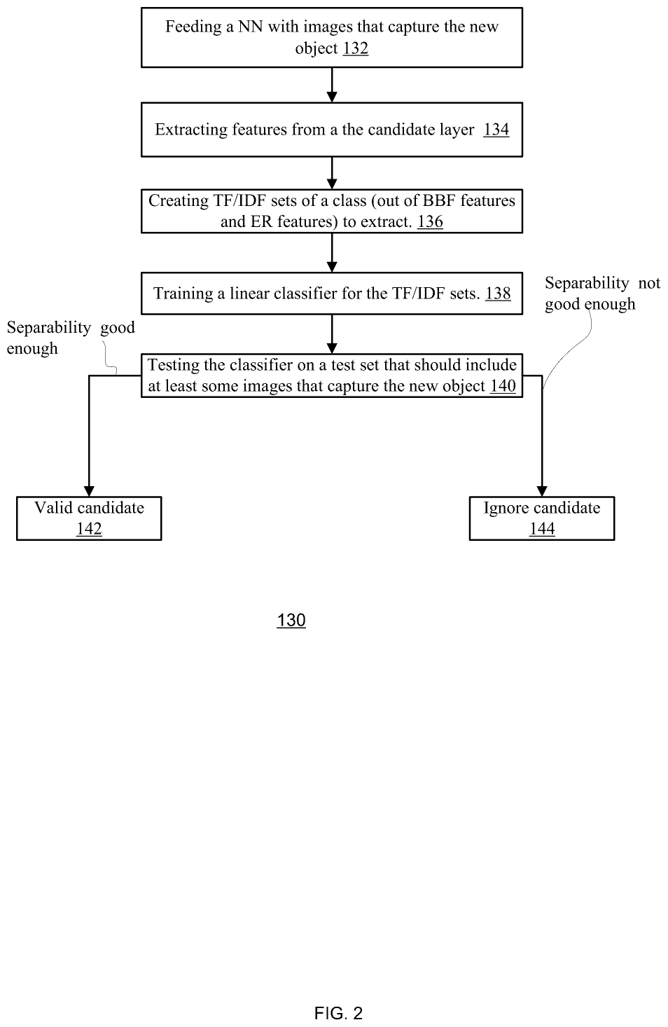

FIG. 2 illustrates an example of method 130 of evaluating a candidate layer in relation to the detection of a new object.

Method 130 starts by step 132 of feeding a NN with images that capture the new object.

Step 132 may be followed by step 134 of extracting features from a the candidate layer.

Step 134 may be followed by step 136 of creating TF/IDF sets of a class (out of BBF features and ER features) to extract.

Step 136 may be followed by step 138 of training a linear classifier for the TF/IDF sets.

Step 138 may be followed by step 140 of testing the classifier on a test set that should include at least some images that capture the new object.

If the classifier exhibits at least a predefined separability-then the candidate layer may be a valid candidate—as illustrated by step 142—in which a separation metric is calculated.

If the classifier exhibits a separability that is below the predefined separability—then the candidate layer may not be a valid candidate—as illustrated by step 144.

FIG. 13 is an example of an image 150 of a vehicle—the image captures a vehicle 151 that is bounded within bounding shape 152, wherein vehicle segment 153 is located at about the center of the bounding shape.

The images also include the surroundings of the vehicle—such as road 154, wherein road segment 155 is located outside the bounding shape 152.

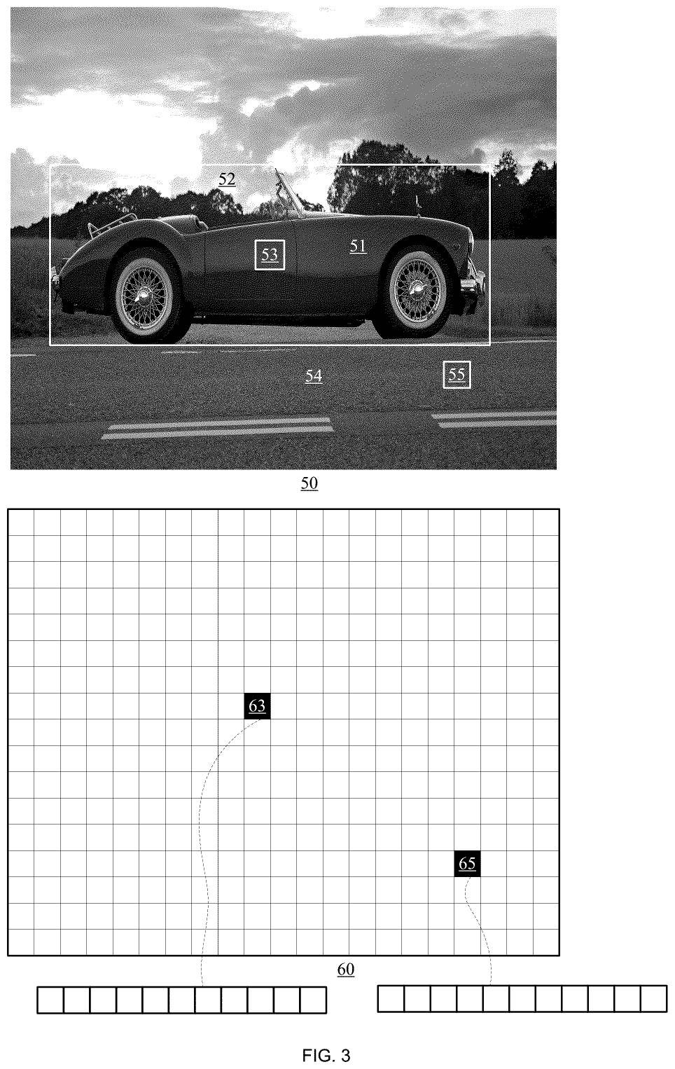

FIG. 3 also illustrates a feature map 60 of one of the layers of a neural network—and also illustrates a feature 63 associated with vehicle segment 53 and feature 65 is associated with road segment 55.

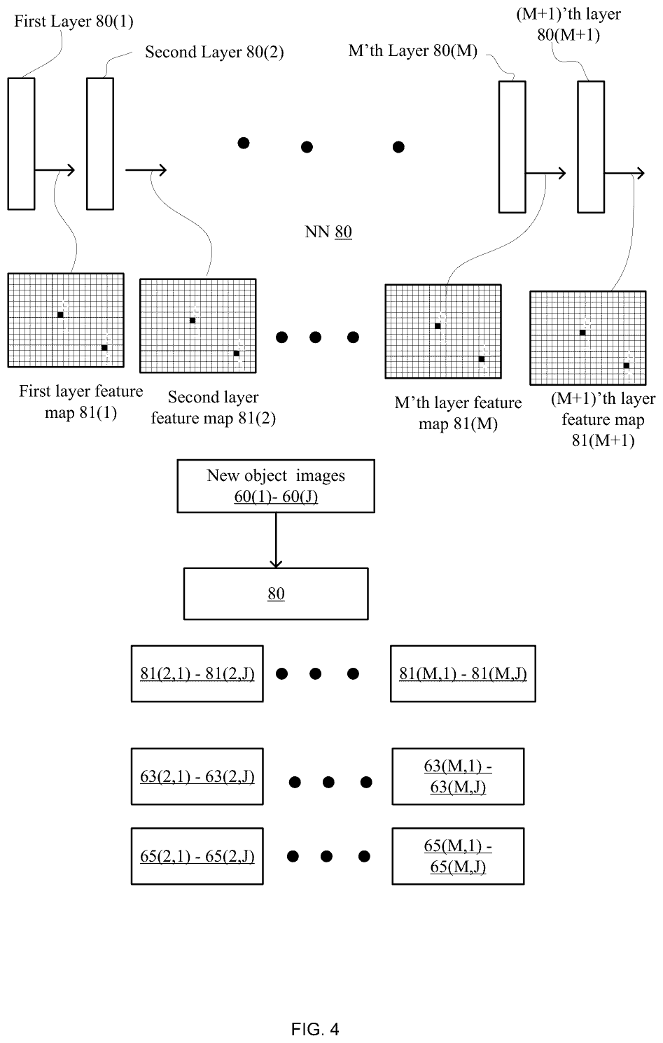

FIG. 4 illustrates an example of a neural network 60, feature maps 81(1)-81(M+1), new object images 60(1)-60(J), J feature maps (81(2,1)-82(2,J)) generated by the second layer in response to the J new object images, and J feature maps (81(M,1)-82(M,J)) generated by the M′th layer in response to the J new object images.

The J feature maps (81(2,1)-82(2,J)) of the second layer include J vehicle features 63(2,1)-63(2,J) (that are related to vehicle segment 63), and J road features 65(2,1)-65(2,J) (that are related to road segment 65).

The J feature maps (81(M,1)-82(M,J)) of the M′th layer include J vehicle features 63(M,1)-63(M,J) (that are related to vehicle segment 63), and J road features 65(M,1)-65(M,J) (that are related to road segment 65).

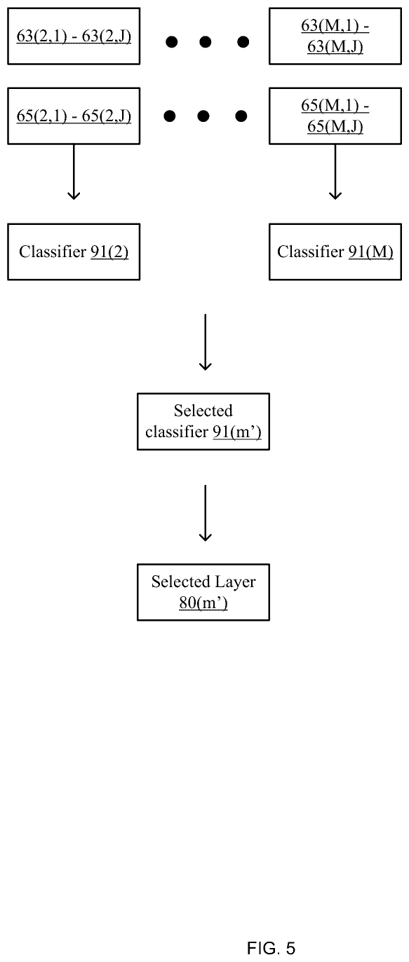

FIG. 5 illustrates an example of features and classifiers.

A classifier 91(2) is related to the second layer and is built to distinguish between J vehicle features 63(2,1)-63(2,J) and J road features 65(2,1)-65(2,J).

A classifier 91(M) is related to the second layer and is built to distinguish between J vehicle features 63(M,1)-63(M,J) and J road features 65(M,1)-65(M,J).

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within the same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Rather the scope of the embodiments of the disclosure is defined by the appended claims and equivalents thereof.

1. A method that is computer-implemented and is for transfer learning, the method comprises:
(a) obtaining new object images and new object bounding shape information indicative of new object bounding shapes that are indicative of dimensions of a new object, wherein each new object image includes a new object that is associated with a new object bounding shape of the new object bounding shapes;
(b) feeding the new object images to a neural network (NN) that is trained to detect objects that differ from the new object;
(c) generating, per each layer out of a group of candidate layers of the NN and for each new object image of the new object images, (i) a features map regarding a new object bounding shape of the new object image, and (ii) a features map regarding an external region of the new object image, the external region is located outside the new object bounding shape of the new object image;
(d) building, per each layer out of a group of candidate layers of the NN, an object classifier configured to distinguish between a bounding shape region related to the new object and an external region related to the new object; wherein an object classifier of a corresponding layer is built based on (i) features maps, generated by the corresponding layer, regarding the bounding shape region, and (ii) features maps, generated by the corresponding layer, regarding the external region;
(e) selecting, out of the group of candidates layers, a selected layer, wherein the selecting is based on a comparison between one or more classifier parameters of object classifiers associated with the candidates layers; and
(f) associating the selected layer with a detection of the new object.

2. The method according to claim 1, wherein the associating includes adding a new branch to the NN, wherein the branch starts from the selected layer.

3. The method according to claim 1, comprising training the new branch to detect the new object and generate a bounding shape around the new object.

4. The method according to claim 1 wherein the one or more classifier parameters comprise a sensitivity index.

5. The method according to claim 1, wherein the NN is a convolutional NN.

6. The method according to claim 1, comprising repeating steps (a)-(f) for another new object to provide another selected layer associated with a detection of the other new object, wherein the other new object differs from the new object and from the certain objects.

7. The method according to claim 6, wherein the other selected layer is selected regardless of the selecting of the selected layer associated with the new object.

8. A non-transitory computer readable medium storing instructions that, when executed by at least one processor, cause the at least one processor to perform operations for transfer learning, comprising:
(a) obtaining new object images and new object bounding shape information indicative of new object bounding shapes that are indicative of dimensions of a new object, wherein each new object image includes a new object that is associated with a new object bounding shape of the new object bounding shapes;
(b) feeding the new object images to a neural network (NN) that is trained to detect objects that differ from the new object;
(c) generating, per each layer out of a group of candidate layers of the NN and for each new object image of the new object images, (i) a features map regarding a new object bounding shape of the new object image, and (ii) a features map regarding an external region of the new object image, the external region is located outside the new object bounding shape of the new object image;
(d) building, per each layer out of a group of candidate layers of the NN, an object classifier configured to distinguish between a bounding shape region related to the new object and an external region related to the new object; wherein an object classifier of a corresponding layer is built based on (i) features maps, generated by the corresponding layer, regarding the bounding shape region, and (ii) features maps, generated by the corresponding layer, regarding the external region;
(e) selecting, out of the group of candidates layers, a selected layer, wherein the selecting is based on a comparison between one or more classifier parameters of object classifiers associated with the candidates layers; and
(f) associating the selected layer with a detection of the new object.

9. The non-transitory computer readable medium according to claim 8, wherein the associating includes adding a new branch to the NN, wherein the branch starts from the selected layer.

10. The non-transitory computer readable medium according to claim 8, that stores instructions for training the new branch to detect the new object and generate a bounding shape around the new object.

11. The non-transitory computer readable medium according to claim 8, wherein the one or more classifier parameters comprise a sensitivity index.

12. The non-transitory computer readable medium according to claim 8, wherein the NN is a convolutional NN.

13. The non-transitory computer readable medium according to claim 8, that stores instructions for repeating steps a-e for another new object to provide another selected layer associated with a detection of the other new object, wherein the other new object differs from the new object and from the certain objects.

14. The non-transitory computer readable medium according to claim 13, wherein the other selected layer is selected regardless of the selecting of the selected layer associated with the new object.

15. A computerized system comprising a memory unit and a processing unit, wherein the processing unit is configured to:
(a) obtain new object images and new object bounding shape information indicative of new object bounding shapes that are indicative of dimensions of a new object, wherein each new object image includes a new object that is associated with a new object bounding shape of the new object bounding shapes;
(b) feed the new object images to a neural network (NN) that is trained to detect objects that differ from the new object;
(c) generate, per each layer out of a group of candidate layers of the NN and for each new object image of the new object images, (i) a features map regarding a new object bounding shape of the new object image, and (ii) a features map regarding an external region of the new object image, the external region is located outside the new object bounding shape of the new object image;
(d) build, per each layer out of a group of candidate layers of the NN, an object classifier configured to distinguish between a bounding shape region related to the new object and an external region related to the new object; wherein an object classifier of a corresponding layer is built based on (i) features maps, generated by the corresponding layer, regarding the bounding shape region, and (ii) features maps, generated by the corresponding layer, regarding the external region;
(e) select, out of the group of candidates layers, a selected layer, wherein the selecting is based on a comparison between one or more classifier parameters of object classifiers associated with the candidates layers; and
(f) associate the selected layer with a detection of the new object.

16. The computerized system according to claim 15, wherein the associating includes adding a new branch to the NN, wherein the branch starts from the selected layer.

17. The computerized system according to claim 15, that stores instructions for training the new branch to detect the new object and generate a bounding shape around the new object.

18. The computerized system according to claim 15, wherein the one or more classifier parameters comprise a sensitivity index.

19. The computerized system according to claim 15, wherein the NN is a convolutional NN.

20. The computerized system according to claim 15, that stores instructions for repeating steps (a)-(f) for another new object to provide another selected layer associated with a detection of the other new object, wherein the other new object differs from the new object and from the certain objects.
